(19) United States
(12) Patent Application Publication
(10) Pub. No.: US 2018/0294114 A1
(43) Pub. Date: Oct. 11, 2018

(54) LUMINOUS KEYBOARD

(71) Applicant: Primax Electronics Ltd., Taipei (TW)

(72) Inventor: CHE-WEI YANG, Taipei (TW)

(21) Appl. No.: 15/701,979

(22) Filed: Sep. 12, 2017

(30) Foreign Application Priority Data
Apr. 7, 2017 (TW) 106111731

(51) Int. Cl. H01H 13/83; H01H 13/705

(52) U.S. Cl. CPC H01H 13/83; H01H 13/705; H01H 2219/06; H01H 2233/05; H01H 2233/07

(57) ABSTRACT

The present invention relates to a luminous keyboard, including a light emitting module capable of generating a beam, keys, and a deckle board. The key includes a keycap. The deckle board is located between the key and the light emitting module, and includes through holes and inclined-surface walls. The keycap stretches into a corresponding through hole. Due to disposition of the inclined-surface wall, the width of an upper end of the through hole is less than the width of a lower end of the through hole. Therefore, the inclined-surface wall can partially cover the keycap, to prevent the beam from leaking out through the through hole. Therefore, the luminous keyboard of the present invention can alleviate a halo phenomenon.

### FIELD OF THE INVENTION

The present invention relates to an input apparatus, and in particular, to a luminous keyboard having a light emitting function.

### BACKGROUND OF THE INVENTION

Common peripheral input apparatuses of a computer include a mouse, a keyboard, a trackball, and the like. The keyboard is able to directly input a character and a symbol to the computer. Therefore, the keyboard receives quite a lot of attentions from users and input apparatus manufacturers. The subject of this specification is a keyboard.

Referring to FIG. 1, FIG. 1 is a schematic diagram of an exterior structure of a conventional keyboard. A plurality of keys 10 is disposed on a surface of a conventional keyboard 1. The keys 10 are classified into common keys 101, number keys 102, function keys 103, and the like. The keys are to be pressed by fingers of a user, to generate corresponding signals, and the signals are provided to a computer, so that the computer executes functions of the pressed keys. For example, the common keys 101 are configured to input symbols, such as English letters, the number keys 102 are configured to input numbers, and the function keys 103, such as F1 to F12, are configured to provide various functions. The conventional keyboard 1 is a keyboard of a notebook computer.

With evolution of technologies, keyboard manufacturers are devoted to developing various keyboards having special functions, so as to meet various requirements of different users, and a luminous keyboard finds most favor with users. The appearance of a conventional luminous keyboard is roughly the same as that of the conventional keyboard 1. However, as the luminous keyboard provides a function that a key emits light, the internal structure of the luminous keyboard differs from that of a conventional keyboard having no light emitting function. The internal structure of the conventional luminous keyboard is described below. Referring to FIG. 2, FIG. 2 is a schematic structural sectional view of a conventional luminous keyboard. A conventional luminous keyboard 2 includes a plurality of keys 20 (only one key is shown in FIG. 2), a membrane switch circuit 21, a light guide plate 22, a light emitting element 23, a baseboard 24, a circuit board 25, and a deckle board 26. The key 20 includes a keycap 201, a scissor-type connection element 202, and an elastic element 203. In the conventional luminous keyboard 2, the foregoing elements are arranged from top to bottom in an order: the keycap 201, the scissor-type connection element 202, the elastic element 203, the membrane switch circuit 21, the light guide plate 22, and the baseboard 24. The light emitting element 23 and the circuit board 25 are located on one side of the membrane switch circuit 21, and the deckle board 26 is located above the membrane switch circuit 21 and encircles the key 20. The conventional luminous keyboard 2 is a keyboard of a notebook computer (not shown).

In the key 20, the keycap 201 is exposed out of the conventional keyboard 2 to be pressed by a user. The scissor-type connection element 202 is configured to connect the keycap 201 and the baseboard 24. The elastic element 203 passes through the scissor-type connection element 202 and separately contacts the keycap 201 and the membrane switch circuit 21. The membrane switch circuit 21 located at the elastic element 203 is able to be pressed against by the elastic element 203, to generate a key signal. The circuit board 25 is located on one side of the membrane switch circuit 21, and the light emitting element 23 is disposed on the circuit board 25, so that a beam B generated by the light emitting element 23 is projected into the light guide plate 22. The light guide plate 22 is able to guide the beam B to be projected into the keycap 201. The light emitting element 23 is a lateral light emitting diode.

The deckle board 26 includes a plurality of through holes 261, and each of the through holes 261 is corresponding to one key 20. The deckle board 26 prevents the beam B from passing through, so that the beam B is projected onto the keycap 201 as much as possible. By means of the foregoing structure, the keys 20 of the conventional luminous keyboard 2 are able to emit light. However, the beam B is apt to leak out from the through holes 261 of the deckle board 26. Consequently, a halo is generated on the periphery of the keycap 201, and interferes with vision of a user.

Therefore, the luminous keyboard capable of alleviating a halo phenomenon is needed.

### SUMMARY OF THE INVENTION

An objective of the present invention is to provide a luminous keyboard capable of alleviating a halo phenomenon.

In a preferred embodiment, the present invention provides a luminous keyboard, including a light emitting module, a plurality of keys, and a deckle board. The light emitting module is configured to generate a beam. The plurality of keys is located above the light emitting module, where at least one of the plurality of keys includes a keycap, and the beam is projected to the keycap, so that the keycap emits light. The deckle board is located between the keycap and the light emitting module, and is configured to block the beam. The deckle board includes a plurality of through holes and a plurality of inclined-surface walls. Each of the through holes is corresponding to one keycap, and the keycap stretches into the through hole. Each of the inclined-surface walls encircles one of the through holes and partially covers one keycap, and is configured to prevent the beam from leaking out through the through holes.

In short, the inclined-surface wall is disposed on the deckle board of the luminous keyboard of the present invention, so that the width of an upper end of the through hole is less than the width of a lower end of the through hole. In this way, a structure that a gap between the keycap and the deckle board is covered by the inclined-surface wall is formed. Therefore, the beam does not leak out from the gap between the keycap and the deckle board. In addition, the keycap includes an inclined-surface outer edge, and the inclined-surface outer edge is capable of being blocked by a corresponding inclined-surface wall, to prevent the keycap from falling off the through hole. Therefore, the inclined-surface wall not only can prevent the beam from passing through, but also can block the keycap, but does not affect up and down motion of the keycap.

### BRIEF DESCRIPTION OF THE DRAWINGS

FIG. 1 is a schematic diagram of an exterior structure of a conventional keyboard;

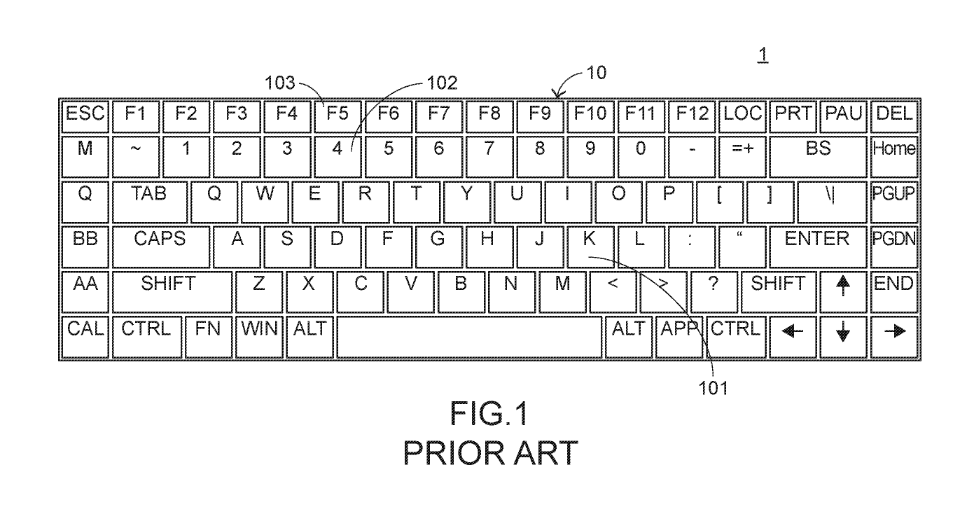

FIG. 2 is a schematic sectional view of a structure of a conventional luminous keyboard;

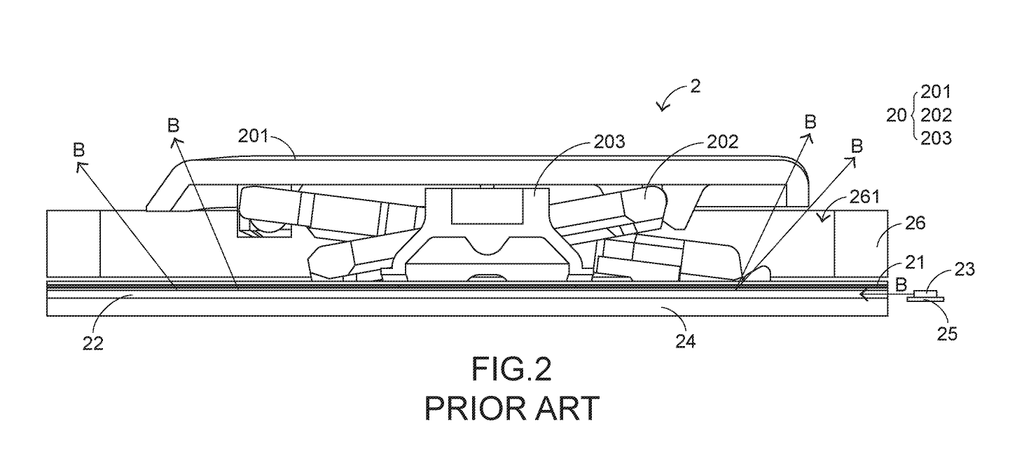

FIG. 3 is a schematic diagram of an exterior structure of a luminous keyboard and a notebook computer according to a preferred embodiment of the present invention;

FIG. 4 is a schematic exploded view of a partial structure of a luminous keyboard according to a preferred embodiment of the present invention;

FIG. 5 is a schematic sectional view of a structure of a luminous keyboard according to a preferred embodiment of the present invention; and

FIG. 6 is a schematic exploded view of a partial structure of a pressed luminous keyboard according to a preferred embodiment of the present invention.

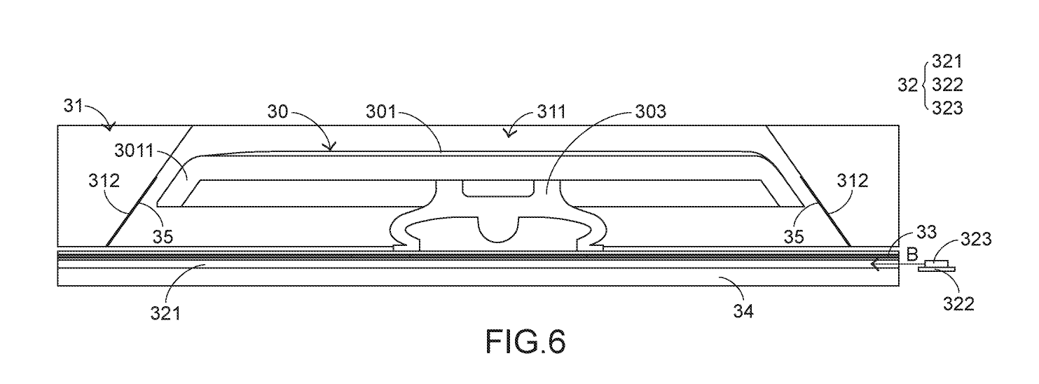

### DETAILED DESCRIPTION OF THE PREFERRED EMBODIMENT

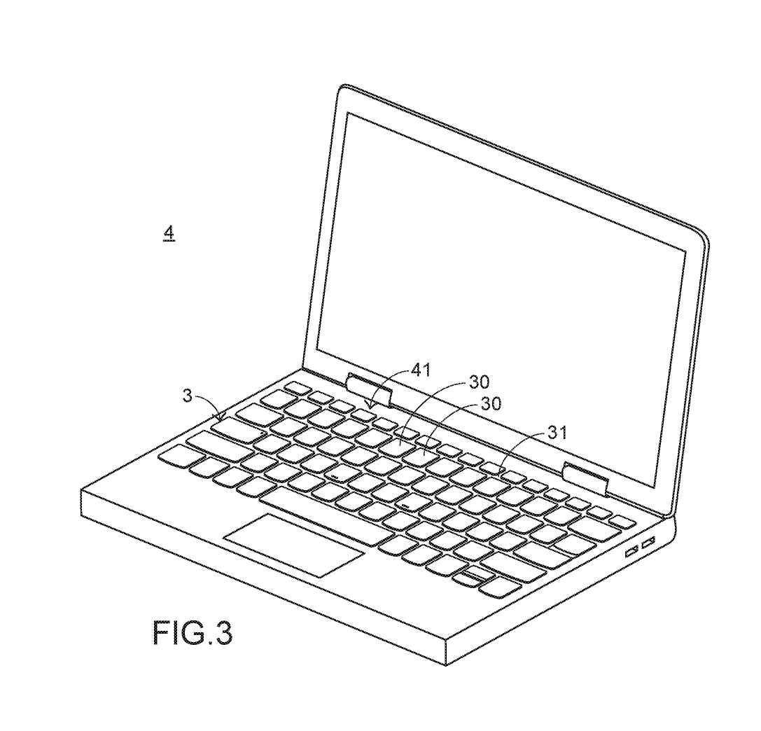

In view of the puzzlement caused by the conventional technologies, the present invention provides a luminous keyboard capable of resolving the problem of the prior art. First, referring to FIG. 3, FIG. 3 is a schematic diagram of an exterior structure of a luminous keyboard and a notebook computer according to a preferred embodiment of the present invention. The luminous keyboard 3 in the present invention is disposed on a base 41 of the notebook computer 4, and the luminous keyboard 3 includes a plurality of keys 30 and a deckle board 31. The plurality of keys 30 and the deckle board 31 are exposed out of the base 41. The plurality of keys 30 are to be pressed by fingers of a user, to generate corresponding signals, and the signals are transmitted to the notebook computer 4, so that the notebook computer 4 executes functions of the pressed keys.

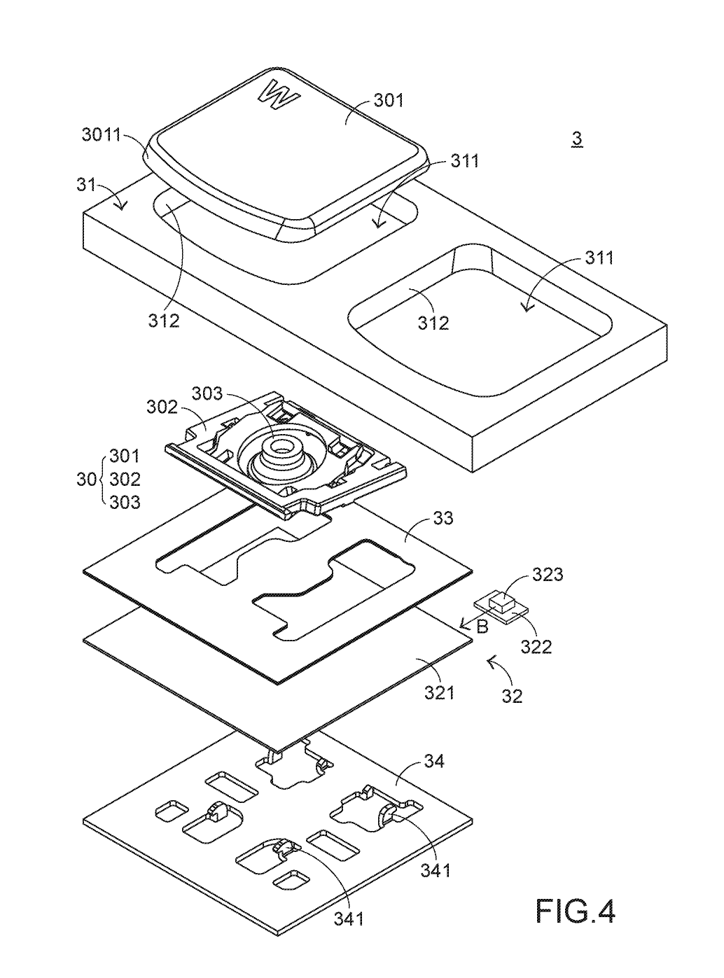

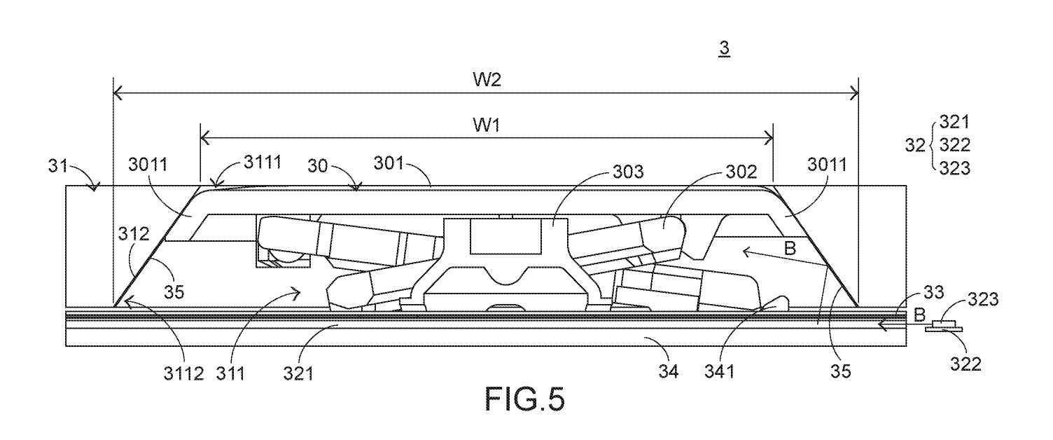

The internal structure of the luminous keyboard 3 in the present invention is described below. Referring to both FIG. 4 and FIG. 5, FIG. 4 is a schematic exploded view of a partial structure of a luminous keyboard according to a preferred embodiment of the present invention, and FIG. 5 is a schematic sectional view of a structure of a luminous keyboard according to a preferred embodiment of the present invention. FIG. 4 and FIG. 5 show structures of keys 30 and a deckle board 31. Each key 30 includes a keycap 301, a connection element 302, and an elastic element 303. In addition to the plurality of keys 30 and the deckle board 31, the luminous keyboard 3 in the present invention further includes a light emitting module 32, a switch circuit board 33, and a baseboard 34. The light emitting module 32 located below the plurality of keys 30 includes a light guide plate 321, a circuit board 322, and a light emitting element 323. The light emitting element 323 is disposed on the circuit board 322 and is located on one side of the light guide plate 321. The function of the light emitting element 323 is generating a beam B and enabling the beam B to enter the light guide plate 321. The light guide plate 321 is disposed on the baseboard 34, and is able to guide the beam B to be projected to the keycap 301. The circuit board 322 is disposed on one side of the baseboard 34, and is able to transmit power to the light emitting element 323. In this preferred embodiment, the circuit board 322 is a printed circuit board (PCB), and the light emitting element 323 is a lateral light emitting diode.

The baseboard 34 is disposed below the switch circuit board 33, is connected to the plurality of keys 30, and is able to bear the plurality of keys 30, the switch circuit board 33, and the light guide plate 321. The baseboard 34 includes a plurality of hooks 341, capable of being connected to the plurality of connection elements 302 of the keys 30. The connection elements 302 are separately connected to the keycap 301 and the hooks 341, so as to fasten the keycap 301 onto the baseboard 34, and enable the keycap 301 to move up and down relative to the baseboard 34. On the other hand, the switch circuit board 33 is located below the plurality of keys 30, and is able to be triggered by the keys 30 so as to output corresponding key signals. The elastic element 303 located below the keycap 301 is able to be pushed and pressed against by the keycap 301, so as to trigger the switch circuit board 33. In the preferred embodiment, the connection element 302 is a scissor-type connection element, and the elastic element 303 is an elastic rubber body.

In FIG. 4 and FIG. 5, the deckle board 31 is located between the keycap 301 and the light emitting module 32, and has two functions: 1. blocking the beam B to avoid light leakage; 2. blocking the keycap 301 to prevent the keycap 301 from falling off the deckle board 31. The deckle board 31 includes a plurality of through holes 311 and a plurality of inclined-surface walls 312. Each through hole 311 is corresponding to one keycap 301, and the keycap 301 stretches into the corresponding through hole 311. Each inclined-surface wall 312 is corresponding to one through hole 311, encircles the corresponding through hole 311, partially covers the corresponding keycap 301, and is able to prevent the beam B from leaking out through the through hole 311. On the other hand, the keycap 301 includes an inclined-surface outer edge 3011. The inclined-surface outer edge 3011 is disposed in a peripheral region of the keycap 301 and is corresponding to the inclined-surface wall 312. The inclined-surface outer edge 3011 is blocked by the corresponding inclined-surface wall 312, so as to prevent the keycap 301 from falling off the through hole 311. It can be seen from FIG. 5 that due to the structure of the inclined-surface wall 312, the width W1 of an upper end 3111 of the through hole 311 is less than the width W2 of a lower end 3112 of the through hole 311.

A situation that the key 30 is pressed to run is described below. When a user presses the keycap 301 of the key 30, the keycap 301 moves downward relative to the deckle board 31 and the baseboard 34, so that the connection element 302 is pushed and pressed against to sway. Moreover, the keycap 301 moving downward pushes and presses against the elastic element 303, so that the elastic element 303 is pressed against to deform and triggers the switch circuit board 33, to generate a corresponding key signal. When the user no longer presses the key 30, the keycap 301 moves upward relative to the deckle board 31 and the baseboard 34 due to elastic force generated when the elastic element 303 restores from a deformed state, so as to push the keycap 301 to move upward. At the same time, the connection element 302 is driven to sway, so that the keycap 301 restores to a position before pressing.

On the other hand, when the light emitting element 323 is driven to generate the beam B, the beam B is projected to the light guide plate 321 and is totally reflected inside the light guide plate 321, so that the beam B is guided by the light guide plate 321 and projected to the keycap 301. In this way, the keycap 301 generates a light emitting effect. Because the deckle board 31 uses a structure of the inclined-surface wall 312, a gap between the keycap 301 and the deckle board 31 can be covered by the inclined-surface wall 312. Therefore, the beam B is blocked by the inclined-surface wall 312 when passing through the gap between the keycap 301 and the deckle board 31. Therefore, a halo phenomenon does not occur. In a preferred practice, the luminous keyboard 3 further includes a reflection layer 35. The reflection layer 35 may be disposed on the inclined-surface wall 312, to reflect the beam B from the light guide plate 321, so that the beam B is projected to the keycap 301. Therefore, use efficiency of the beam B can be improved.

There are three aspects needing to be specially noted: 1. The light guide plate 321 in the preferred embodiment is disposed on the baseboard 34, and is used as an example only, and the present invention is not limited thereto. In fact, the light guide plate may also be disposed below the baseboard as required, and the baseboard is provided with a corresponding hole, so that a beam passes through the hole. 2. The light emitting element 323 is not limited to a lateral light emitting diode, which is used as an example only. The light emitting module of the luminous keyboard in the present invention may also use a direct-type light emitting diode, and the direct-type light emitting diode is disposed below the keycap. In this way, the light guide plate does not need to be disposed in a light emitting module. 3. It is not limited that a manner of fixing the keycap is limited to using a scissor-type connection element, and the keycap may also be fixed and enabled to move up and down relative to the baseboard by using a connection element in another form or a magnetic-type structure.

It can be known from the foregoing that the inclined-surface wall is disposed on the deckle board of the luminous keyboard of the present invention, so that the width of an upper end of the through hole is less than the width of a lower end of the through hole. In this way, a structure that a gap between the keycap and the deckle board is covered by the inclined-surface wall is formed. Therefore, the beam does not leak out from the gap between the keycap and the deckle board. In addition, the keycap includes an inclined-surface outer edge, and the inclined-surface outer edge is capable of being blocked by a corresponding inclined-surface wall, to prevent the keycap from falling off the through hole. Therefore, the inclined-surface wall not only can prevent the beam from passing through, but also can block the keycap, but does not affect up and down motion of the keycap.

The foregoing descriptions are merely preferred embodiments of the present invention, but are not intended to limit the patent scope of the present invention. Any equivalent changes or modifications made without departing from the spirit disclosed in the present invention shall fall within the patent scope of the specification.

What is claimed is:

1. A luminous keyboard, comprising:
a light emitting module, configured to generate a beam;
a plurality of keys, located above the light emitting module, wherein at least one of the plurality of keys comprises a keycap, and the beam is projected to the keycap, so that the keycap emits light; and
a deckle board, located between the keycap and the light emitting module, configured to block the beam, wherein the deckle board comprises:
a plurality of through holes, wherein each of the through holes is corresponding to one keycap, and the keycap stretches into the through hole; and
a plurality of inclined-surface walls, wherein each of the inclined-surface walls encircles one of the through holes and partially covers one keycap, and is configured to prevent the beam from leaking out through the through hole.

2. The luminous keyboard according to claim 1, wherein the keycap comprises an inclined-surface outer edge, the inclined-surface outer edge is disposed in a peripheral region of the keycap and is corresponding to the inclined-surface wall, and the inclined-surface outer edge is capable of being blocked by the inclined-surface wall, so as to prevent the keycap from falling off the through hole.

3. The luminous keyboard according to claim 1, wherein the width of an upper end of the through hole is less than the width of a lower end of the through hole.

4. The luminous keyboard according to claim 1, further comprising a reflection layer, disposed on the inclined-surface wall, so as to reflect the beam.

5. The luminous keyboard according to claim 1, further comprising:
a switch circuit board, located below the plurality of keys, and configured to be triggered by the key to output a key signal; and
a baseboard, disposed below the switch circuit board, connected to the plurality of keys, and configured to bear the plurality of keys, wherein the baseboard comprises a hook, configured to connect to the key.

6. The luminous keyboard according to claim 5, wherein the key further comprises:
a connection element, separately connected to the keycap and the hook, so as to fasten the keycap onto the baseboard, and enable the keycap to be movable relative to the baseboard; and
an elastic element, located below the keycap, configured to be pushed and pressed against by the keycap to trigger the switch circuit board, wherein when the elastic element is no longer pushed and pressed against by the keycap, the elastic element provides an elastic force to the keycap.

7. The luminous keyboard according to claim 6, wherein the connection element is a scissor-type connection element.

8. The luminous keyboard according to claim 6, wherein the elastic element is an elastic rubber body.

9. The luminous keyboard according to claim 5, wherein the light emitting module comprises:
a light guide plate, disposed on the baseboard, configured to guide the beam to be projected to the keycap;
a circuit board, disposed on one side of the baseboard; and
a light emitting element, disposed on the circuit board, located on one side of the light guide plate, and configured to generate the beam, and enable the beam to enter the light guide plate.
